(19) United States
(12) Patent Application Publication
(10) Pub. No.: US 2015/0048542 A1
(43) Pub. Date: Feb. 19, 2015

(54) DEVICE AND PROCESS FOR CALIBRATING TUBULAR EXTRUDATES

(71) Applicants: Heinz GROSS, Echt (NL); Matheus Pieter QUAEDFLIEG, Echt (NL); Leonardus Wilhelmus Guillaume RIJKS, Echt (NL)

(72) Inventors: Heinz GROSS, Echt (NL); Matheus Pieter QUAEDFLIEG, Echt (NL); Leonardus Wilhelmus Guillaume RIJKS, Echt (NL)

(73) Assignee: DSM IP ASSETS B.V., Heerlen (NL)

(21) Appl. No.: 14/526,345

(22) Filed: Oct. 28, 2014

Related U.S. Application Data
(63) Continuation of application No. 14/241,629.

(30) Foreign Application Priority Data
Aug. 29, 2011 (EP) 11179214.9

(51) Int. Cl. B29C 47/92; B29D 23/00

(52) U.S. Cl. CPC B29C 47/92; B29D 23/00; B29K 2101/00
USPC 264/209.4; 425/171; 425/140

(57) ABSTRACT

The present invention relates to a calibration device for use in a process of making a tubular article comprising a housing and a calibration sleeve providing a vertical pass-way for an extruded tubular extrudate, the housing comprising a bore, an upper opening with an upper seal and a lower opening with a lower seal; a vacuum channel connecting the bore to a vacuum source; a liquid channel for receiving a flow of liquid and connecting to a reservoir on top of the housing; and an adjustment device for controlling the liquid level in the reservoir; and the calibration sleeve comprising a body with multiple apertures and an inlet flange; the calibration sleeve removably positioned in the bore and contacting the housing via the upper and lower seals. This calibration device enables making a tubular article in a very flexible way, specifically on small scale in the laboratory; and can be operated in free or contact calibration mode, both with either dry or wet operation.

The invention further relates to an extrusion system for making tubular articles from a polymer composition comprising such calibration device, and to a process applying such device or system.

This application is a continuation of commonly owned copending U.S. application Ser. No. 14/241,629, filed Feb. 27, 20148 (now abandoned), which is the U.S. national phase of International Application No. PCT/EP2012/066770 filed Aug. 29, 2012 which designated the U.S. and claims priority to EP Application No. 11179214.9 filed Aug. 29, 2011, the entire contents of each of which are hereby incorporated by reference.

The present invention relates to a calibration device comprising a housing and a calibration sleeve, for use in an extrusion process of making a tubular article of desired dimensions, more specifically to such calibration device that is suited for use on laboratory scale. The invention further relates to an extrusion system for making tubular articles from a polymer composition comprising such calibration device, and to a process applying such device or system.

A tubular article, that is a hollow member of certain length and generally of cylindrical form like a pipe or tube, is typically made from a polymer composition, preferably a thermoplastic polymer composition, in an extrusion process using an extrusion system. Such system generally comprises a device for providing the polymer composition in a deformable/flowable state, like a (plasticating) extruder; a device for subsequently shaping it into a tubular extrudate, like an annular die; a device for cooling and solidifying the tubular extrudate, like a cooling chamber or water bath; a device for pulling, drawing, stretching or elongating the tubular extrudate, e.g. a set of rolls; and a device for either winding/coiling the tube or cutting into lengths. Upstream of the extruder further equipment can be used, like a material handling system, a drying unit, a feed hopper, or a dosing/metering unit. Additional downstream equipment may include a gear pump, a calibration device, and a unit to measure tube dimensions like diameter and wall thickness. Considering the number of units and total length of such extrusion line, the process is typically operated in a horizontal plane.

Choice of equipment depends on many factors, amongst others on the scale of operation, e.g. commercial production vs laboratory evaluation, and type of product to be made. In general, a pipe is a large diameter annular product, typically having outside diameter of greater than 25 mm, and is rigid; small diameter flexible product is generally referred to as tube. Such tubular product having even smaller dimensions, e.g. below 1 mm, is also called a hollow fibre.

Tubes of relatively small diameter, for example in a range of about 10 mm and below, are often made with a so-called ‘free’ extrusion process; meaning an extrusion process that does not apply a sizing or calibration sleeve for controlling outer dimension of the tube. The diameter and wall thickness of the tube are then primarily determined by extruder output, die design, cooling rate and take-up or puller speed (determining draw-down or draw ratio); in addition to material properties, e.g. viscoelasticity and drawing behaviour of the polymer composition being processed. Better dimensional control can be obtained by controlling air flow and pressure within the tubular extrudate or member during processing, e.g. by injecting air via the die into the hollow extrudate. Dimensions will be frozen by properly cooling the extrudate and solidifying the polymer composition. Cooling can be done by using a gas (air) flow, or by cooling with a liquid; e.g. by spraying water or by leading the tube through a water bath. Typically the former process is referred to as ‘dry’ and the latter as ‘wet’.

Processes for making pipes or tubing with accurate dimensional control—e.g. diameter, roundness or wall thickness—generally apply a calibration device; which is typically positioned shortly after the die, and may also serve for cooling the extrudate. The calibration device, also called sizing device, generally comprises a housing and a calibration sleeve fitted therein, which sleeve provides a pass way for the extruded hollow (tubular) member. The sleeve is typically provided with cooling means and multiple orifices or apertures offset with respect to one another in both circumferential and axial direction. The pressure in the housing area around the sleeve can be reduced with a vacuum system via the orifices, resulting in the passing tubular extrudate being forced or sucked into contact with the inner wall of the sleeve; this way controlling or calibrating the outer diameter of the tubular extrudate. Such processes applying calibration sleeves and devices, referred to as ‘contact’ or ‘vacuum’ calibration or extrusion, have been described in many publications. For example, DE2239747A1 describes a device wherein the sleeve is provided with suction slits and channels for cooling liquid (water). Such a ‘dry contact’ method may pose problems with the extrudate adhering to the wall, resulting in e.g. surface defects or other processing difficulties. Application of a liquid, typically water, for combined cooling and lubricating action to the tubular extrudate, by spraying through apertures in the sleeve (in addition to the suction openings) and/or applying at the entrance side of the sleeve around the extrudate (e.g. via a water ring), and optionally via grooves on the internal surface of the sleeve is disclosed in for example U.S. Pat. No. 5,085,567 and EP1201399A1. Also in this ‘wet contact’ operation the tubular extrudate passes the sleeve horizontally, and problems with adherence and temperature profiles in the cooling bath still occur. Such problems are addressed in EP2226178A2 with a calibration device comprising means for rotating cooling fluid around the tubular extrudate, resulting in a liquid cooling sleeve.

In practice, an extrusion system is preferably used to produce pipes of different diameters. As this would require stopping production and replacing at least the calibration sleeve, calibration devices have been developed of which the sleeve diameter can be adjusted during operation. Examples of such devices are described in for example DE10157190A1, WO2004/091891A1, US20060185183A1, US7357630B2, and WO2010/105598A2.

The known calibration devices, however, pose several problems when aiming to process only limited amounts of material into a tube on laboratory scale, especially if its processing characteristics are not (well) known. First of all, a considerable amount of material, such as several kg, may be needed already for making an initial extrudate and passing this through the device. Secondly, before starting experiments a choice would have to be made for type of calibration; for example dry versus wet, free versus contact operation, etc. In addition, adjusting the outer dimension of the tube by adjusting a calibration device is often laborious, or requires a complicated device with an adjustable sleeve.

It is therefore the object of the present invention to provide a calibration device that does not show at least some of the disadvantages of prior art equipment, and which can be used in small scale laboratory processing.

This problem is solved according to the invention by providing the embodiments as described herein below and as characterized in the claims. Accordingly, the present invention provides a calibration device for use in a process of making a tubular article, the device (100) comprising a housing (200) and a calibration sleeve (300) providing a vertical pass-way for a tubular extrudate,
the housing comprising a bore (210), an upper opening with an upper seal (280) and a lower opening with a lower seal (285); a vacuum channel (215) connecting the bore to a vacuum source; a liquid channel (255) for receiving a flow of liquid and connecting to a reservoir (250) on top of the housing; and an adjustment device for controlling the liquid level in the reservoir; and
the calibration sleeve comprising a body with multiple apertures (340) and an inlet flange (330); the calibration sleeve removably positioned in the bore and contacting the housing via the upper and lower seals.

The calibration device according to the invention surprisingly enables making a tubular article in a very flexible way, specifically on small scale in the laboratory. The tubular extrudate passing vertically through the calibration device enables easy and quick start-up and guiding the extrudate from extruder die into the sleeve while minimising sagging and deformation problems. Vertical vs conventional horizontal operation further allows better control of temperature of the tubular extrudate, resulting in a well-defined product. A further advantage of this calibration device is that it can be operated in free or contact calibration mode, and both with either dry or wet operation; and the type of operation can be changed inline simply by controlling internal pressure, liquid level in the top reservoir, or both pressure and liquid level. As such changes from dry calibration to wet calibration or from wet calibration to dry calibration can be made during operation, little material and time is wasted in finding optimal processing mode and conditions. If a different diameter is desired for vacuum mode operation, the calibration sleeve can be quickly and easily exchanged. By using a device of proper size and suitable other equipment like an extruder and die, tubular articles of wall thickness as small as about 0.1 mm from as little as only several grams of polymer composition, such as down to about 20 g, may be made.

Further advantages during wet operation in the vertical extrusion process of the invention include more homogeneous and constant temperature of the liquid around the extrudate; whereas in horizontal tube calibration vertical temperature gradients—resulting from water being heated while flowing downward around the tube, or from density differences in a water bath—can hardly be avoided. The device and process of the invention enable more uniform cooling, and lower tendency of the extrudate to deform, like forming of a non-cylindrical (oval) cross-section in free extrusion mode.

The calibration device according to the invention can be used in a process of making a tubular article, the external diameter of which may vary within large limits, for example from 0.1 to 200 mm; that is from a hollow fibre to a pipe. Depending on the size of the tube to be made, the skilled person will be able to choose proper dimensioning of the calibration device, specifically of the sleeve but also other components, and of further auxiliary equipment needed.

The calibration device according to the invention is especially suitable for use on a laboratory scale, in combination with small size extrusion and auxiliary equipment. Laboratory scale refers to processing relatively small amounts, e.g. less than 100 g, of polymer compositions. During research or development activities on for example new grades or types of polymers, sample material may be available only in limited amounts, for example from about 5 to 50 g; depending e.g. on the size of polymerisation reactor. Another suitable application is processing of polymer compositions or formulations that contain special additives, which additives are very expensive or available in only minute quantities, like certain active pharmaceutical or biological ingredients (API). The device of the invention enables for example mixing or dispersing API in an excipient matrix, and forming into a sample form suited for first clinical evaluation. Alternatively, the device can be used for small scale production purposes. For amongst others these reasons the device preferably comprises a sleeve having an internal diameter of at most 25 mm, more preferably the internal diameter is at most 20, 15, 12 or even 10 mm. As making very small tubes with vacuum calibration may create too much friction and damage to the extrudate, the sleeve has an internal diameter of preferably at least 1 mm, or more preferably at least 1.5, 2, 3, 4, 5 or 6 mm. Within the context of this application internal diameter of the sleeve refers to the minimum distance between opposite sides of the inner wall of the sleeve, generally of oval or circular cross-section; which determines the outer dimension of the tube made therewith. Very small diameter tubes with diameter below for example 1 mm, also referred to as hollow fibres, are preferably made with a free extrusion process where the calibration sleeve is not in contact with the tube during the process.

It is preferred that the calibration device and corresponding extruder and die are arranged vertically during operation, as this allows for easier handling of the as-extruded relatively soft tubes, particularly for laboratory scale equipment suited for small amounts of sample material, such as 5 to 50 g sample material.

The sleeve in the calibration device according to the invention can be of a fixed diameter size, but also an adjustable sleeve can be used; for example a sleeve as described in WO2010/105598A2. Considering the ease of changing a sleeve with present device, and its simplicity, preferably a sleeve of fixed size and geometry is applied.

The length of sleeve in the calibration device according to an embodiment of the invention is not critical, but typically the sleeve has a length that is about 3 to 10 times its internal diameter. However, this ratio may be higher for thin tubes, as the length is fixed by the housing whereas the replaceable calibration sleeves may vary in inner diameter for example from 25 mm to 1 mm for the same housing.

The sleeve in the calibration device according to the invention preferably comprises a cylindrical body. Within the context of the present application cylindrical is understood to include a hollow tube with virtually constant, perfect circular cross-section, but also deviating geometries like a conical form. It may also be advantageous that the sleeve has somewhat larger diameter at the top inlet side, and/or at the bottom outlet side. In addition, the cross-section may not be circular, but of for example oval shape. Preferably, the sleeve has an essentially circular cross-section along its length.

The sleeve in the calibration device according to the invention comprises a body with an inlet flange; i.e. a flange located close to an inlet opening. The flange has a wider diameter than the outer diameter of the sleeve, and serves to contact the sleeve with the top part of the housing, preferably via an air-tight sealing between flange edge and housing via an upper seal (see later). The flange diameter is preferably of a certain fixed size for use with a certain calibration device, while sleeve diameter or geometry may vary. The sleeve is further contacted with the housing at a lower part of its body via a lower seal. In combination with the contact at the top, this serves to secure the sleeve in a vertical position in the bore of the housing, and to create an internal cavity around the sleeve's external body surface, the pressure of which cavity can be reduced via a vacuum channel communicating with a vacuum source.

The inlet flange is typically located close to the inlet opening of the sleeve. The inlet flange can for example be attached to the sleeve body at the inlet, and form part of the inlet, or alternatively be situated somewhat below the inlet opening on the outer surface of the body, such that the sleeve body with inlet protrudes from the flange. The inlet opening is preferably rounded, i.e. without a sharp edge, and somewhat larger than the internal diameter of the sleeve; which makes receiving the extruded member easier and prevents damaging the surface thereof.

In a preferred device of the invention, the inlet flange forms part of the inlet opening. The inlet flange and opening can have various geometries, like a trumpet-like form. In one embodiment, the inlet opening is rounded with a radius of curvature that is at least 0.2 times the inner diameter of the calibration sleeve. This may for example reduce the risk that the tube is cut by the first interaction with the inlet opening or reduce wear of the tube. Preferably the radius of curvature is at least 0.3 times the inner diameter and more preferably the radius of curvature is at least 0.4 times the inner diameter. Particularly preferred is the embodiment where the inlet flange forms part of inlet opening with the transition from the calibration sleeve to the flange following the above mentioned minimum inner diameters of curvature. The maximum diameter of curvature is determined by the space available but typically the inlet opening is rounded with a radius of curvature that is at most about 5 times the inner diameter of the calibration sleeve such as at most about 2 times to the inner diameter of the calibration sleeve.

Preferably, in a device according to the invention the sleeve has an inlet opening that extends (or protrudes) relative to the contact point of flange and housing (via a seal), to create a barrier for liquid flowing from the reservoir around and into contact with the tubular extrudate, and/or into the sleeve; or stated otherwise a certain minimum fluid level in the reservoir is needed for the liquid being able to flow over the barrier and contact the tubular extrudate, and to result in ‘wet mode’ operation. This barrier thus provides the option to operate the device in either dry or wet mode, by controlling the liquid level in the reservoir to respectively below or above the inlet opening (also referred to as barrier or upper level of the inlet flange) in a very flexible way. The barrier height—or distance from flange, i.e. its contacting point with the housing, to inlet opening—may vary depending on size of the device, and can be from 0 to about 20 mm, preferably about 2-10 mm.

Preferably, the calibration sleeve has a rounded or curved and very smooth inlet flange and opening, for example of a ‘collar’ form; to create said liquid barrier and a smooth inlet for the extrudate.

The sleeve in the calibration device according to the invention comprises a cylindrical body provided with multiple apertures. Typically, the upper (inlet) and lower (outlet) parts of the sleeve do not have such radial openings. Preferably, the apertures are offset with respect to one another in both circumferential and axial direction; and may for example be arranged in spirals. By reducing pressure in the bore or cavity around the sleeve, the passing tubular extrudate can be sucked into contact with the internal wall of the sleeve via these orifices; this way controlling or calibrating the outer diameter of the tubular extrudate. In order to prevent or at least minimize the chance the extrudate is damaged or material is entering the apertures, the openings are relatively small, preferably smaller than the wall thickness of the sleeve body, and preferably have smoothened edges. Preferably, aperture size is smaller than 1 mm, more preferably in the range 1-0.01 mm, or 0.5-0.05 mm. Smaller aperture sizes are preferred as this reduces the risk that the tube will be sucked into and stuck in an aperture and further allows for finely distributed apertures leading to a very even pressure (vacuum) between the calibration sleeve and the tube. Smaller apertures may for example be realized by (laser) drilling of a metal tube or by a porous metal or ceramic structure for example realized by sintering of metal or ceramic particles. It will be clear that in case only free extrusion operation mode will be targeted, the sleeve does not need to comprise such apertures.

In a further preferred embodiment of the invention, the sleeve is provided with grooves on its internal surface, for example spirally progressing from the inlet. The advantage hereof is that in wet calibration mode liquid can travel more easily with the tubular extrudate, providing cooling and lubrication. As for apertures, such grooves are preferably smoothened to prevent sharp edges that may cause damage to the tubular extrudate.

The sleeve in the calibration device according to the invention can be made from different materials, provided they are stable at processing conditions. The sleeve is preferably made from metal, more preferably from brass, aluminium, or stainless steel. Preferably, the sleeve and all other relevant parts are made from a stainless steel grade that is approved for use in contact with material for biomedical or pharmaceutical applications. Such device and sleeve can be used for processing for example active pharmaceutical ingredients, or materials or compositions for biomedical applications, in accordance with industry guidelines or standards (e.g. Good Manufacturing Practice (GMP) compliant).

The calibration device according to the invention comprises a housing, wherein the calibration sleeve is removably positioned; providing a vertical pass way for an extruded tubular member. Removably positioned is understood to mean that one sleeve can be exchanged for another. The housing has an opening or bore, which is designed for receiving a sleeve of the largest sleeve diameter to be used. After inserting the sleeve into the bore and sealingly fitting it in the housing by contacting the inlet flange via an upper seal, and a lower part of the sleeve body with a lower seal, an internal cavity is created on at least a part of the outer surface of the calibration sleeve, which internal cavity communicates via a channel with a vacuum source to adjust (reduce) pressure in the cavity. The seals can be made from different materials as known to a skilled person, preferably from resilient or elastic material like a silicone rubber. The upper seal may for example be an O-ring, the lower seal is preferably able to contact sleeves of different diameters, like a flexible sheet or film with a round or other opening.

The calibration device according to the invention comprises a housing having a liquid channel for receiving a flow of liquid. This liquid can serve to control the temperature of the housing, and also to cool and/or lubricate the extruded member. The liquid used is not particularly critical and the skilled person will be able to select a suitable liquid, for example depending on the polymer composition to be processed. Preferably the liquid comprises water; and can be an aqueous solution, or substantially water. The liquid may for example be sourced from a (water) bath the temperature of which is regulated to a desired value, and be returned to this bath. After passing through the housing the channel leads to a reservoir on top of the housing, which is situated on the upper part of the housing. Said reservoir can for example be defined by the top surface of the housing, the inlet flange of the sleeve, and optionally other components like a top cap. The liquid in this reservoir may further function to control the housing temperature, and can be used for cooling and lubricating the tubular extrudate in wet mode operation.

In one embodiment, the reservoir is open to the atmosphere whereby the pressure above the reservoir corresponds to the ambient pressure (typically about 1 atmosphere) irrespective of the flow of liquid into and from the reservoir and irrespective of the liquid level in the reservoir. When the liquid level is above the upper level of the inlet flange this allows for water entering into the sleeve at no or very low pressure (typically less than 1 mm water column) and at virtually same pressure from all sides of the inlet flange. Hence a very stable and homogeneous liquid film may be formed. If on the contrary, liquid is entering the sleeve from a closed reservoir (as for example disclosed in U.S. Pat. No. 4,886,634), pressure will be required to drive the liquid into the sleeve leading to pressure on the tube to be calibrated as well as variation in pressure around the calibration sleeve (due to pressure being higher close to the liquid inlet to the closed reservoir). Particularly, for tubes having very low wall thickness, such as for example 0.1-0.2 mm, variation in liquid pressure due to the effects of using a closed reservoir is sufficient to observe variation in realized wall thickness.

The calibration device according to the invention comprises an adjustment device for controlling the liquid level in the reservoir, enabling to switch between dry and wet mode of operation while using the same calibration device. In a preferred embodiment, this may be achieved by adjusting the liquid level in the reservoir between a first level where the level of the liquid in the reservoir is below the upper level of the inlet flange and a second level where the level of the liquid in the reservoir is above the upper level of the inlet flange. The skilled person will be able to select a suitable adjustment device, depending on the specific design of the calibration device. In one embodiment, the liquid level is controlled via an overflow of adjustable height, which overflow communicates with a channel that for example removes the liquid, or returns it to the bath from which it was sourced. The adjustment device preferably is operable during operation of the calibration sleeve, so that the calibration mode may be adjusted inline, which is highly advantageous when working with new or unknown samples where the optimum processing parameters have not yet been established. Preferably, the calibration device according to the invention further comprises a removable top cap, which may further secure the sleeve via its flange in contact with the housing, define the top reservoir, and comprise the adjusting device for the liquid level in the reservoir. The top cap is preferably connected to the housing with a suitable quick-release fastening mechanism, such as a bayonet system, mating pins and slots, and the like; to allow quick changing of sleeves.

In a further preferred embodiment the calibration device according to the invention comprises a substantially circular housing and removable top cap, the two components being connectable via a rotating mechanism, like a screw thread or bayonet. The housing and top cap circumferences, openings provided therein and the fitted sleeve are then preferably all concentric. In a preferred embodiment, the calibration device comprises an adjustable overflow made up from a plurality of overflow positions of different heights on such rotatable top cap, only one selected position being aligned with and communicating with a fluid return channel in the housing.

The invention further relates to an extrusion system for making a tubular article from e.g. a polymer composition comprising the calibration device according to the invention. Such extrusion system may comprise following devices as generally known to a person skilled in the art, like
a device for providing a polymer composition in a deformable or flowable state, like a (plasticating) extruder;
a device for subsequently shaping the polymer composition into a tubular member or extrudate, like an annular die;
a calibration device according to the invention; and
a device for tensioning, pulling, drawing, stretching or elongating the tubular extrudate, for example a set of (driven) rolls.

Upstream of the extruder further equipment can be used, like a material handling system, a drying unit, a dosing/metering unit, and/or a feed hopper. Additional downstream equipment may include a gear pump, a device for further cooling and solidifying the tubular extrudate, like a cooling chamber or water bath, a unit to measure tube dimensions like diameter and wall thickness, and/or a device for either winding or coiling the tube, or cutting it into lengths. Process control units may also be included in the system.

With the extrusion system according to the invention a variety of polymer compositions may be processed in a relatively short time. Preferably the polymer compositions are based on a thermoplastic polymer material. The composition may comprise one or more polymers, customary additives and fillers or reinforcing agents, solvents or pore forming agents, etc. Also depending on the type of composition to be processed, the skilled person will be able to select suitable equipment. As the calibration device of the invention offers especially advantages in processing small amounts of sample material, other devices in the extrusion system should be suited for such purpose as well.

Preferably, the extrusion system according to the invention therefore comprises an extruder that can process less than 100 g of polymer composition into a homogenous molten mixture, more preferably such extruder can process less than 75, 50, 40, 25, 20, 15, 10 g or even about 5 g of composition. Such laboratory- or micro-extruders or compounders are marketed by for example DSM Xplore (see e.g. www.xplore-together.com), and are described in for example WO2006/077147A1. A further advantage of such micro-extruder is that it can be operated in a semi-batch mode using a recirculation channel, which for example allows to temporarily stop the polymer composition from exiting the die, and to exchange the calibration sleeve or change operating mode without wasting material.

Preferably, the extrusion system according to the invention, specifically such system suitable for processing small amounts of polymer composition, comprises a so-called spiral mandrel die, for homogeneous melt distribution and stable processing the composition into a tubular extrudate. Such dies have been described in many publications, including WO88/01226A1 and US2002/0163099A1. Considering often little material can be wasted during operation, an annular die that can be quickly and easily centered to provide a tubular extrudate with even wall thickness distribution is preferred. A suitable annular die based on an elastic tilt joint centering mechanism has been disclosed in for example WO2011/072650A1 and Extrusion International 16, July 2010, p 52-55.

Preferably, the extrusion system according to the invention, specifically such system suitable for processing small amounts of polymer composition, comprises a tensioning device comprising at least two rolls which frictionally engage with the tubular article. A suitable device for processing small amounts of material, wherein the speed of at least one of the tensioning rolls is controlled by a micro-stepping mechanism, is described in WO2005/113217A1. Such equipment is marketed by DSM Xplore (see e.g. www.xplore-together.com).

The invention further relates to a process for making a tubular article from a polymer composition applying a calibration device or an extrusion system according to the invention, wherein a tubular extrudate is substantially vertically extruded from a die and passed through a calibration sleeve. In this process, the annular die and calibration sleeve are preferably substantially vertically and co-axially aligned.

In an embodiment, the inlet flange of the calibration sleeve is arranged inside the reservoir and the inlet flange has a horizontal upper level surrounding the calibration sleeve. In the process according to the invention the inlet flange and opening of the calibration sleeve are preferably substantially horizontally aligned, to ensure a homogeneous flow of fluid to the tubular extrudate in wet operating mode, thereby providing even cooling and lubrication to the tube. Substantially horizontally as well as substantially vertically is understood to encompass small deviations from exactly horizontally and vertically, which deviations do not significantly affect producing a tubular article with the desired level of homogeneity. Preferably, deviations from the horizontal plane or vertical axis are less than 5 degrees)(°), preferably less than 3°, more preferably less than 1°, and most preferably less than 0.5, 0.3 or even 0.1°.

The process according to the invention can be operated in free or contact calibration mode, and both with either dry or wet operation, by adjusting internal cavity pressure and/or liquid level in the top reservoir. It is a particular advantage of the process that such changes can be made during operation.

Preferably, the process of the invention is operated in wet contact mode, by reducing pressure around the sleeve to below atmospheric and increasing the fluid level in the reservoir to above the inlet opening of the sleeve.

The process according to the invention can make tubular articles of different external diameters, for example from 0.1 to 200 mm, preferably 1 to 25 mm; as defined above for sleeve dimensions.

The process according to the invention can make tubular articles having a range of wall thicknesses. Preferably an article is made having wall thickness of less than 5 mm, more preferably less than 2 mm or 1.5 mm, even more preferably less than 1.0, 0.8 or 0.6 mm, and most preferably less than 0.5 mm. A thinner wall results in a more flexible tubular article, which is of advantage in various applications, including biomedical use such as an implant or for controlled drug release. The wall thickness is preferably at least 0.05 mm, more preferably at least 0.1 mm or 0.2 mm, and most preferably at least 0.4 mm; a thicker wall increases mechanical properties and integrity.

In a preferred embodiment, the process according to the invention is started and initially operated in wet mode; water preventing sticking of the extrudate to the sleeve. This way, proper operating conditions like extruder screw speed, temperature settings, alignment of devices, etc. can be efficiently identified. While stably operating in either free or contact wet mode, the dimensions of the extrudate are measured, and if wall thickness distribution is not fully homogeneous over the cross-section the annular die may be adjusted (centered) until an even or centric thickness distribution is obtained. When extrusion die and calibration device have been optimally adjusted and aligned to result in a tubular article with very even thickness distribution, take-up speed can be increased. In contact calibration mode, this may be used to affect the wall thickness of the tube. In case of free extrusion, diameter and wall thickness of the extrudate can be decreased by increasing the speed of take-up rolls, i.e. by drawing or stretching of the extrudate. This way, the process of the invention enables making of low diameter hollow fibres, of course also depending on processing and drawing characteristics of the polymer composition.

With the process according to the invention a variety of polymer compositions may be processed, preferably based on a thermoplastic polymer material. The composition may comprise one or more polymers, excipients, customary additives and fillers or reinforcing agents, solvents or pore forming agents, plasticizers, active ingredients, etc.

The process of the invention offers especially advantages in processing small amounts of sample material, like new grades or types of polymers, or other sample material that is available only in limited amounts or that is very expensive, for example less than 100 g. The process can also advantageously be used for processing of polymer compositions that contain special additives, which additives are very expensive or available in only minute quantities, like certain active pharmaceutical ingredients or biologically active compounds.

Preferably, in the process according to the invention less than 100 g of polymer composition is processed into a tubular article, more preferably to process less than 75, 50, 40, 25, 20, 15, 10 or even about 5 g of polymer composition. If only such limited quantities of sample material are available, it may be advantageous to first identify suitable process configuration and conditions by processing another polymer composition that has similar processing and rheological characteristics.

One embodiment of the invention concerns a method of manufacturing hollow tubes of two different outer diameters in an extrusion system. It was found that this may advantageously be achieved by an extrusion system comprising a calibration device according to the present invention by providing an as-extruded hollow tube (from an die that received the extruded material from an extruder) to the calibration device with a first calibration sleeve. The hollow tube is then transported through the first calibration sleeve of the calibration device while adjust the outer diameter of the hollow tube to the inner diameter of the first calibration sleeve of the calibration device and the hollow tube with outer diameter adjusted to the inner diameter of the first calibration sleeve may hence be collected. Thereafter the first calibration sleeve is replaced with a second calibration sleeve in the calibration device, where the second calibration sleeve has a different inner diameter than the first calibration sleeve. Again, an as-extruded hollow tube is provided to the calibration device (now with a second calibration sleeve installed), and the hollow tube is transported through the second calibration sleeve of the calibration device while adjust the outer diameter of the hollow tube to the inner diameter of the second calibration sleeve of the calibration device and the hollow tube with outer diameter adjusted to the inner diameter of the second calibration sleeve may be collected. It should be observed that the changing of calibration sleeve from the first calibration sleeve to the second calibration sleeve with preferred embodiments of the calibration device typically may be conducted within a few minutes. Changing of the calibration sleeve in a traditional calibration device would require a rebuilding of the whole calibration device, so considerable time and resources may be saved by utilizing the present invention.

Another embodiment of the invention is related to the process of optimizing the calibration process for a new or unknown sample. Here, it is utilized that an embodiment of the present invention may change calibration mode during use (inline). One aspect concerns a method of manufacturing hollow tubes in an extrusion system wherein the calibration method is changed from dry calibration into wet calibration by actuating the device for controlling the liquid level in the reservoir from providing a water level below the upper level of the inlet flange to a water level above the upper level of the inlet flange. Another aspect of the same principle concerns changing the calibration method from wet calibration into dry calibration. This may be realized by actuating the device for controlling the liquid level in the reservoir from providing a water level above the upper level of the inlet flange to a water level below the upper level of the inlet flange.

Throughout the description and claims of this specification, the words “comprise” and “contain” and variations of the words, for example “comprising” and “comprises”, means “including but not limited to”, and is not intended to and does not exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

It is further understood that any combination between different embodiments and preferred features as described herein can be made and form part of the invention, whether such combination is explicitly mentioned or not.

The invention will be further illustrated with following description of some preferred embodiments of the calibration device according to the invention and accompanying schematic drawings, wherein:

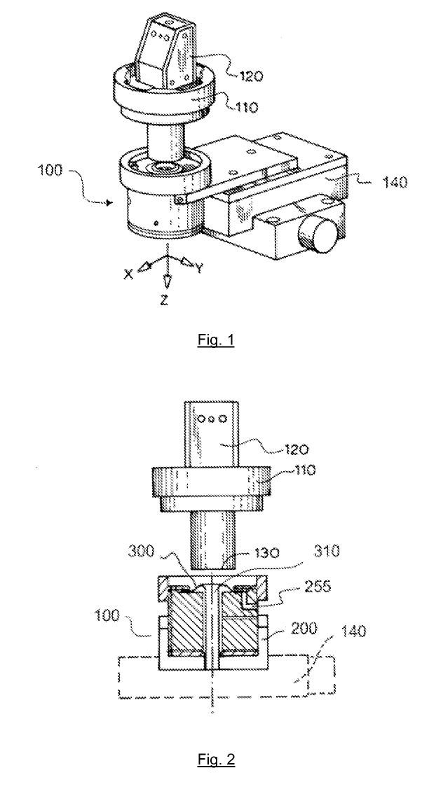

FIG. 1 is a perspective view of an apparatus comprising a calibration device of the present invention;

FIG. 2 is a cross-sectional view of the calibration device of FIG. 1;

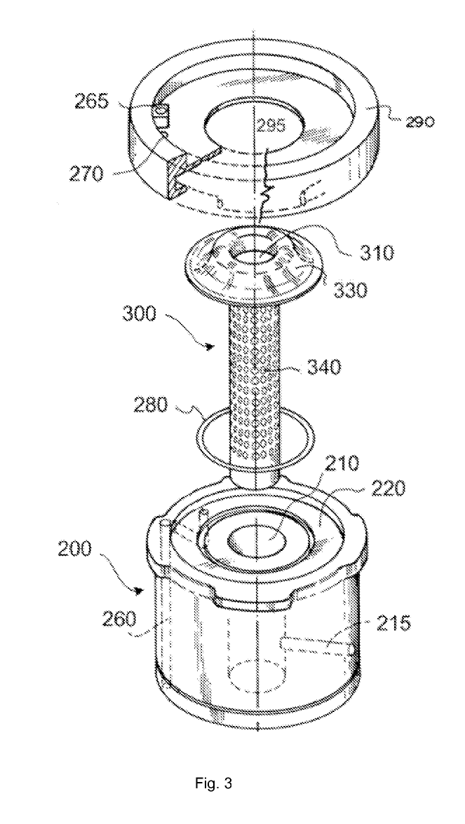

FIG. 3 is an exploded view of a calibration device of the invention;

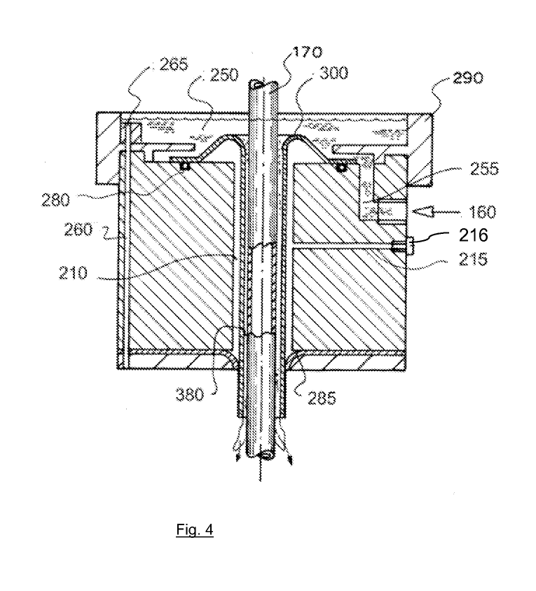

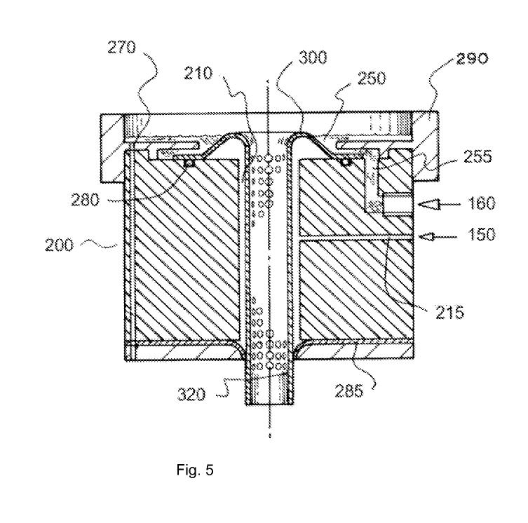

FIG. 4 is a cross-sectional view of a calibration device operating in “wet free mode”;

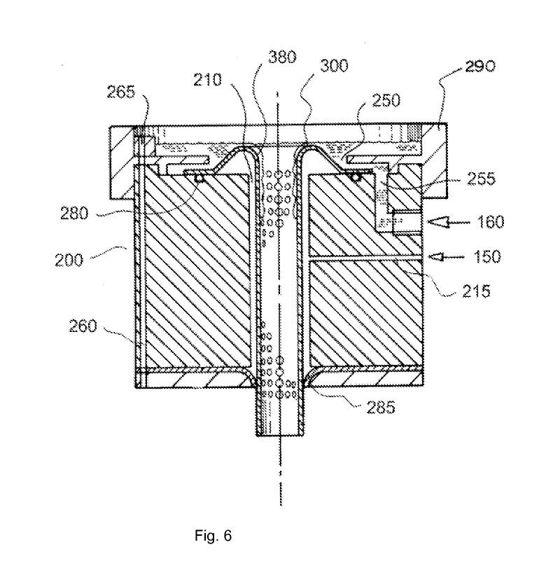

FIG. 5 is a cross-sectional view of the device of FIG. 4, operating in “dry contact mode”;

FIG. 6 is a cross-sectional view of the device of FIG. 4, operating in “wet contact mode”.

In these figures, the same reference numbers are used for identical or similar parts. The drawings are simplified and schematic and not necessarily to scale, and not all details and potential reference numbers may be shown to avoid cluttering.

FIGS. 1 and 2 depict a calibration device 100, attached to a support 140 that is movable and/or tiltable with respect to an annular extrusion die 110, and a connection 120 to an extruder or other device that provides a polymer composition in flowable state (not shown). The die and calibration device are vertically arranged in line (Z axis), such that a tubular extrudate (170) leaving the die at 130 (not shown) is positioned right above the inlet opening of the sleeve 300, which is mounted in housing 200 (diameter of the extrudate being smaller than internal diameter of the sleeve). Support 140 can be precisely moved in X, Y and Z directions to fully align the calibration device at known distance from the die, for reproducibility of experiments. In addition, support 140 allows aligning inlet opening 310 of the sleeve in a substantially horizontal plane, such that cooling/lubricating liquid flows evenly along the internal surface of the calibration sleeve, thereby forming a liquid film layer 380 of uniform thickness (see e.g. FIG. 4).

FIG. 3 provides more details on such calibration device for use in a process of making a tubular article. Housing 200 comprises a central opening or bore 210 for receiving calibration sleeve 300, the opening connecting via channel 215 to a vacuum source 150 (not shown). The top surface 220 of the housing has an area around bore 210 for supporting flange 330 of sleeve 300. Top surface 220 of the housing is further provided with protrusions at its edges forming a bayonet fastening mechanism in cooperation with top cap 290. A reservoir 250 is defined on the top part of the housing by housing surface 220 and cap 290, communicating via liquid channel 255 with a water source 160. The housing also comprises fluid return channel 260 that can communicate with top reservoir 250 via overflows 265 and 270, respectively, by rotating top cap 290 into desired position; this way functioning as an adjustment device for controlling liquid level. The combination 260-265 will result in a higher liquid level in the reservoir than 260-270.

Calibration sleeve 300 comprises a cylindrical body provided with multiple apertures 340 and a flange 330 connected to inlet 310 via a rounded or curved collar, together also called inlet flange. O-ring 280 will provide a good connection between flange 330 and housing top surface 220, with mounted top cap 290 further securing the connection (with the inlet sleeve opening accessible through opening 295).

FIGS. 4, 5 and 6 schematically illustrate different operating modes of the same calibration device. FIG. 4 represents ‘wet free mode’, wherein no vacuum is applied to the sleeve; vacuum channel 215 being blocked by a stopper 216. Top cap 290 is positioned such that water from source 160 entering the device via liquid channel 255 can leave top reservoir 250 via overflow 265 and channel 260, resulting in a fluid level higher than the top of curved inlet flange of sleeve 300, forming a water ring and a water layer 380 around tubular extrudate 170. The diameter of the extrudate can be decreased by stretching or drawing the extrudate by increasing the speed of e.g. take-up rolls (not shown).

In FIG. 5 a device is depicted that can be used to make a tubular article (not shown) via ‘dry contact mode’ processing. In this case pressure in the internal cavity—defined by bore 210 and the external surface of the sleeve 300 contacting the housing via flange 330 and upper seal 280, and outer external surface and lower seal 285—is reduced to below atmospheric via channel 215 connecting to vacuum source 150. Top cap 290 is positioned such that water from source 160 entering the device via channel 255 leaves top reservoir 250 via overflow 270 and channel 260, resulting in a fluid level below the top of curved inlet flange of sleeve 300. Water now thus merely serves to keep the housing at the desired temperature. A passing extrudate will be contacted with the internal surface of the sleeve, due to the created pressure difference.

A switch to ‘wet contact mode’ processing can be made, even without stopping a running experiment, by changing setting of the adjustment device; visualised in FIG. 6. Now overflow 265 on the top cap is used, resulting in a higher water level in reservoir 250 and formation of a water ring, and water film around the extrudate (not shown). By changing pressure back to atmospheric, a transfer to wet free extrusion is possible.

1. A calibration device for use in a process of making a tubular article comprising a housing and a calibration sleeve providing a vertical pass-way for an extruded tubular extrudate,
the housing comprising a bore, an upper opening with an upper seal and a lower opening with a lower seal; a vacuum channel connecting the bore to a vacuum source; a liquid channel for receiving a flow of liquid and connecting to a reservoir on top of the housing; and an adjustment device for controlling the liquid level in the reservoir; and
the calibration sleeve comprising a body with multiple apertures and an inlet flange;
wherein the calibration sleeve is removably positioned in the bore and contacting the housing via the upper and lower seals.

2. The calibration device according to claim 1, wherein the reservoir is open to the atmosphere.

3. The calibration device according to claim 1, wherein the inlet flange of the calibration sleeve is arranged inside the reservoir and the inlet flange has a horizontal upper level surrounding the calibration sleeve;

4. The calibration device according to claim 3, wherein during use the adjustment device for controlling the liquid level in the reservoir adjusts the liquid level in the reservoir between a first level where the level of the liquid in the reservoir is below the upper level of the inlet flange and a second level where the level of the liquid in the reservoir is above the upper level of the inlet flange.

5. The calibration device according to claim 1, wherein the sleeve has an internal diameter of from 1 to 25 mm.

6. The calibration device according to claim 1, wherein the sleeve has an inlet opening that extends relative to the contact point of flange and housing.

7. The calibration device according to claim 1, wherein the sleeve has a rounded or curved inlet flange.

8. The calibration device according to claim 1, wherein the adjustment device is an overflow of adjustable height.

9. The calibration device according to claim 1, wherein the device further comprises a removable top cap.

10. Extrusion system for making a tubular article from a polymer composition comprising a calibration device according to claim 1.

11. Process for making a tubular article from a polymer composition applying a calibration device according to claim 1, wherein a tubular extrudate is substantially vertically extruded from a die and passed through the calibration device.

12. The process according to claim 11, wherein the process is operated in wet contact mode by reducing pressure around the calibration sleeve to below atmospheric and increasing the fluid level in the reservoir to above the inlet opening of the sleeve.

13. The process according to claim 11, wherein the tubular article has an external diameter from 0.1 to 25 mm.

14. The process according to claim 11, wherein the tubular article has a wall thickness from 0.05 to 5 mm.

15. The process according to claim 11, wherein less than 100 g of polymer composition is processed into a tubular article.

16. A method of manufacturing hollow tubes of two different outer diameters in an extrusion system according to claim 10 comprising the steps of:
providing an as-extruded hollow tube to the calibration device with a first calibration sleeve,
transporting the hollow tube through the first calibration sleeve of the calibration device while adjust the outer diameter of the hollow tube to the inner diameter of the first calibration sleeve of the calibration device,
collect the hollow tube with outer diameter adjusted to the inner diameter of the first calibration sleeve,
replace the first calibration sleeve with a second calibration sleeve in the calibration device, the second calibration sleeve has a different inner diameter than the first calibration sleeve,
providing an as-extruded hollow tube to the calibration device with a second calibration sleeve,
transporting the hollow tube through the second calibration sleeve of the calibration device while adjust the outer diameter of the hollow tube to the inner diameter of the second calibration sleeve of the calibration device, and
collect the hollow tube with outer diameter adjusted to the inner diameter of the second calibration sleeve.

17. A method of manufacturing hollow tubes in an extrusion system according to claim 10 comprising the step of:
changing the calibration method from dry calibration into wet calibration by actuating the device for controlling the liquid level in the reservoir from providing a water level below the upper level of the inlet flange to a water level above the upper level of the inlet flange, or
changing the calibration method from wet calibration into dry calibration by actuating the device for controlling the liquid level in the reservoir from providing a water level above the upper level of the inlet flange to a water level below the upper level of the inlet flange.
